(19) United States
(12) Patent Application Publication
(10) Pub. No.: US 2021/0113012 A1
(43) Pub. Date: Apr. 22, 2021

(54) STEAM DISPENSING APPARATUSES FOR HOT BEVERAGE PREPARATION

(71) Applicant: Gruppo Cimbali S.p.A., Binasco (MI) (IT)

(72) Inventors: Michele GRANATA, Binasco (MI) (IT); Claudia BARON SAIZ, Binasco (MI) (IT); Luigi MORELLO, Binasco (MI) (IT)

(21) Appl. No.: 17/073,210

(22) Filed: Oct. 16, 2020

(30) Foreign Application Priority Data
Oct. 17, 2019 (IT) 102019000019199

(51) Int. Cl. A47J 31/44; A47J 31/46

(52) U.S. Cl. CPC A47J 31/4489; A47J 31/4485; A47J 31/461

(57) ABSTRACT

A steam dispensing apparatus for preparing hot beverages comprises a boiler, a steam wand, a steam delivery conduit connected to the first outlet of the boiler and configured to deliver steam to the wand and a valve for delivering steam to the wand and draining condensation water. The valve comprises a hollow body, a steam inlet connection, a steam outlet connection and a drain connection for draining condensation water, a rod, which is axially accommodated in said hollow body and able to perform axial movements in either direction along said longitudinal axis, a control lever which is axially engaged with said rod to impart said axial movements thereto.

The present invention relates to a steam dispensing apparatus for preparing hot beverages, having a device for prior drainage of the condensation water formed in the steam conduit, upstream from the valve, during a valve closing time elapsed from a previous steam dispensing operation.

As is known, for example, espresso machines for bars, restaurants and similar facilities, are normally equipped with a boiler for steam generation and a wand for dispensing steam into a container. Conventionally, the steam dispensed by the wand is used for heating and/or frothing the milk intended for preparation of the beverage universally known as “cappuccino”.

More in detail, the boiler comprises an outlet connected via a delivery conduit to a dispensing valve, and in turn, to the steam wand.

Since a certain time period elapses between one steam dispensing operation and another, it will be actually found that, despite the provision of a suitable insulation, the decrease of temperature in the steam delivery conduit, in the section between the outlet of the boiler and the dispensing valve, causes condensation of steam in such section of the conduit.

This causes the formation of condensation liquid which, depending on the size and length of the section of the conduit, as well as of its insulation conditions and the time elapsed from the last steam dispensing operation, can reach and exceed an amount of 10 or 12 grams.

Such condensation liquid, if not removed from the conduit in which it is formed, as steam is being dispensed for heating milk by the steam wand, eventually pours into the heated milk and, given its lower density relative to milk, remains on its surface, thereby causing an unpleasant sensation in the consumer.

In the prior art, attempts have been made to solve the issue of condensation liquid in the steam delivery conduit by various arrangements.

One of these attempts consists in improving the efficiency of the thermal insulation in the section of the conduit which delivers steam to the valve, as disclosed for example in US 20170332825 A1.

A different prior art solution consists in providing a heating element in the section of the conduit where condensation may occur, which is always on between one steam dispensing operation and the other, as disclosed for example in US 20170332832 A1.

These are generally highly expensive and poorly efficient arrangements.

Another prior art alternative consists in removing the condensation liquid formed upstream from the dispensing valve by simply opening the latter and keeping it open for a short period of time, before introducing the steam wand into the fluid to be heated.

Nevertheless, a drawback is noted with this method of operation, in that the condensation liquid is freely drained onto the cup holder of the machine, with the generation of hot water and steam and possible soiling of the countertop.

Therefore, one of the objects of the present invention is to eliminate the condensation water generated in the section of the steam delivery conduit upstream from the dispensing valve, by equipping the latter with a device that can be actuated by the dispensing valve itself, and that can channel the condensation water toward a collection and discharge conduit while causing dispensing of pure steam into the steam wand by an additional operation on the valve.

A further object of the invention is to be able to supply to the beverage heating wand at least one predetermined steam flow, preferably a plurality different steam flows, as determined from preset positions of the control member for opening/closing the valve, to automatically adapt the steam flow according to the type of heating to be provided, which affords positive energy savings as compared to uncontrolled dispensing, like in the use of a conventional valve.

These and other objects, as better explained hereafter, are fulfilled by a steam dispensing apparatus for preparing hot beverages that has the characterizing features as set forth in the accompanying claim 1.

The invention will be now described in greater detail with reference to one embodiment thereof, given by way of illustration and without limitation, and shown in the annexed drawings, in which:

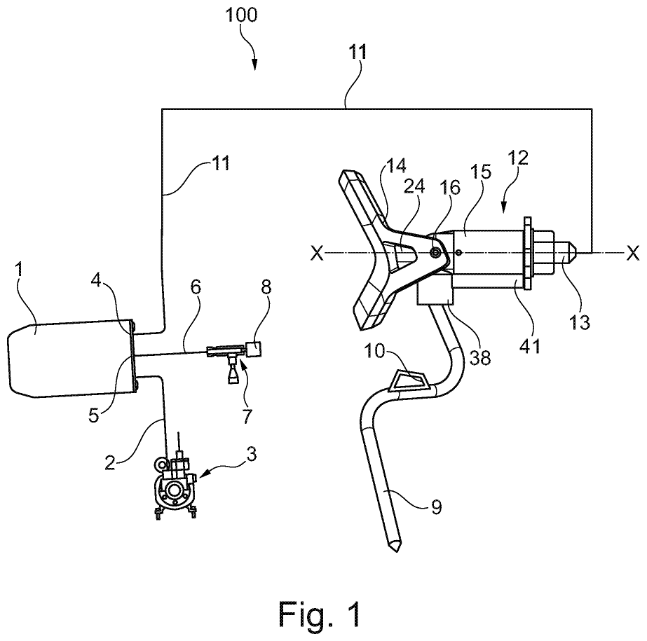

FIG. 1 shows a schematic view of certain elements of a steam dispensing apparatus for preparing hot beverages according to the present invention;

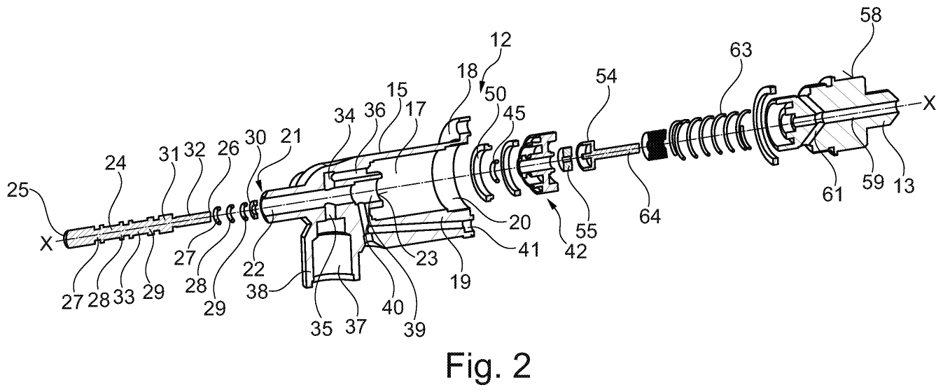

FIG. 2 shows an exploded perspective view of a longitudinal section of the valve;

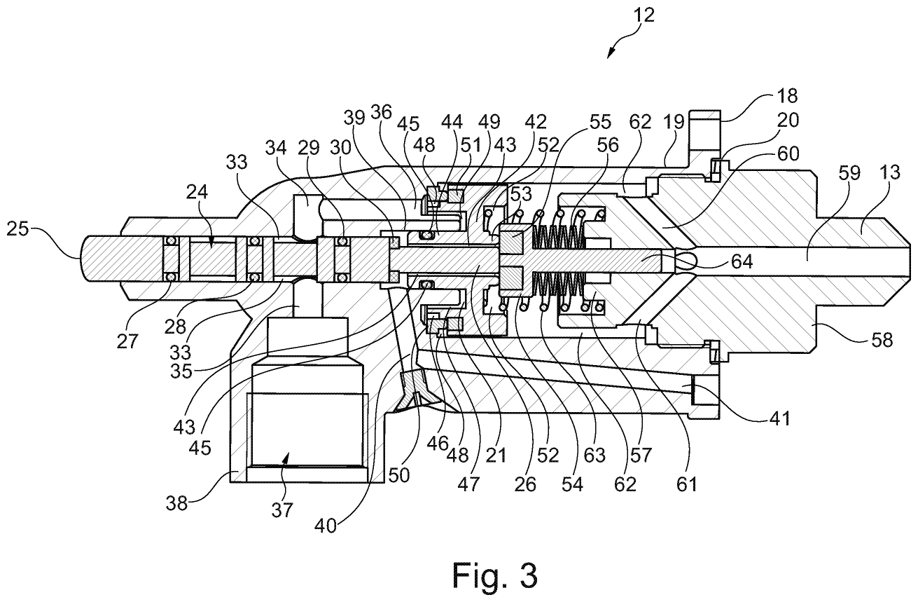

FIG. 3 shows a longitudinal section of the steam dispensing valve, with the condensation water drain device in its standby position;

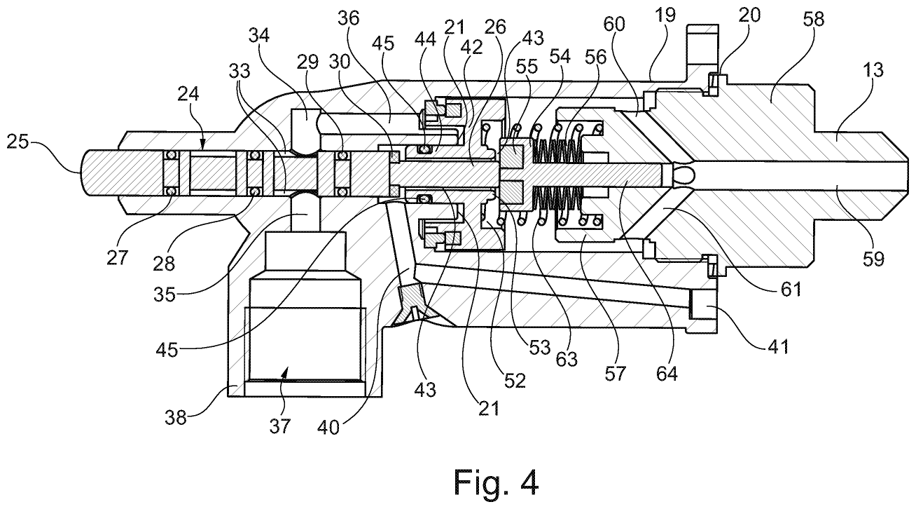

FIG. 4 shows a longitudinal section of the steam dispensing valve, with the condensation water drain device in the drain position;

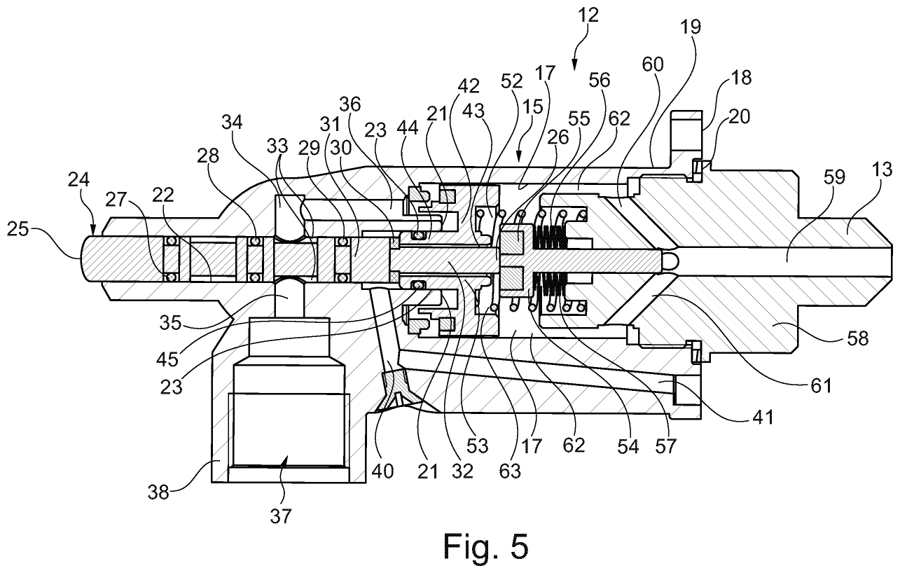

FIG. 5 shows a longitudinal section of the steam dispensing valve, with the condensation water drain device in the steam dispensing position, with a predetermined flow value;

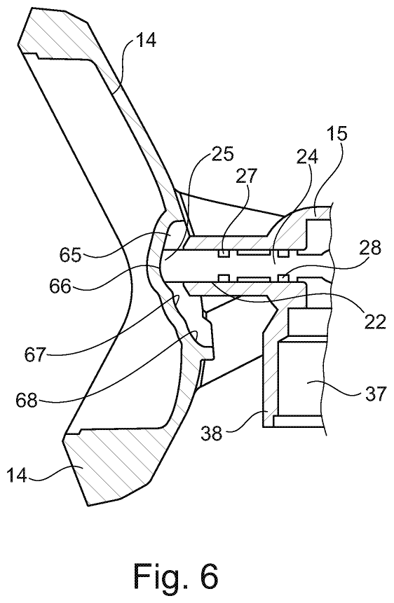

FIG. 6 shows a schematic view of the operational engagement between the control lever for controlling the rod of the valve and the end of said rod;

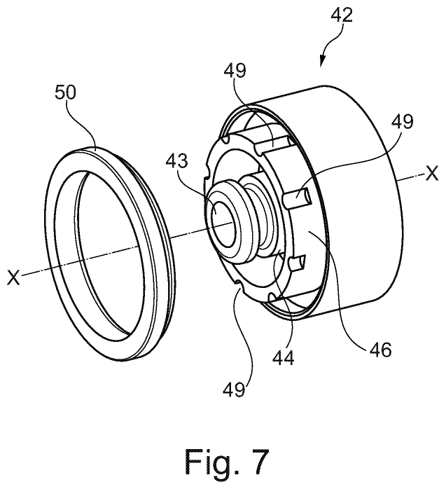

FIG. 7 shows an exploded perspective view of the steam flow regulating body of the valve and its annular member for adjusting the axial opening of the steam delivery slits.

Referring to FIG. 1, the general characteristics of a steam dispensing apparatus 100 for preparing hot beverages, preferably for heating and/or frothing milk, according to the present invention are shown.

The apparatus 100 may be either provided as a stand-alone apparatus or integrated in a machine for preparing hot beverages, e.g. coffee, espresso, cappuccino, tea and the like.

The apparatus 100 comprises a boiler 1 configured to generate steam, a water reservoir (not shown in the annexed figures) and a feed pump 3. This feed pump 3 is configured to draw water from the reservoir and to feed it to the boiler 1 via an inlet conduit 2.

In the steady state, under normal working conditions, the boiler 1 uses the water fed into the inlet conduit 2 to generate a mixture of hot water and steam at an equilibrium temperature of about 120° C.

The boiler 1 comprises a first outlet 4, which is configured to only intercept the vapor phase of the mixture.

The boiler 1 also comprises a second outlet 5, which is configured to only intercept the hot water phase of the mixture, which may be delivered via a conduit 6 to a conventional valve 7, controlled by the angular displacements of a knob 8.

The apparatus 100 further comprises a wand 9 for introducing steam into the liquid to be heated. Preferably, such wand 9 consists of a tubular barrel designed to be immersed into the liquid, for example milk, contained in a container. By introducing steam into the milk, the wand 9 can heat and/or froth it in a conventional manner. Still preferably, such wand 9 has a thermally insulated operating handle 10, which facilitates control and manipulation thereof.

The apparatus 100 further comprises a steam delivery conduit 11 connected to the first outlet 4 of the boiler and configured to deliver the steam to the wand 9.

The conduit 11 is connected to a valve 12 at the connection 13 thereof.

In addition to being used for steam dispensing, the valve 12 also comprises means for prior drainage of the condensation water formed in the steam delivery conduit 11, as well as in the valve itself 12, during the time the latter has been closed since a previous dispensing operation.

Steam is dispensed by controlling a lever 14 which is fixed to the exterior of the cylindrical body 15 of the valve 12 via a pin 16, whereby the lever 14 may be angularly displaced by an operator through various positions, as further described below.

Particularly referring to FIG. 2, the valve 12 comprises the aforementioned cylindrical body 15 having the inner cylindrical cavity 17 and longitudinally extending along an axis referenced X-X.

The hollow body 15 also has a flange 18 for connection to a support member, not shown, which is placed around the end 19 having a first opening 20 formed therein.

The support member may form part of a support frame of the apparatus 100 or a frame of a machine for preparing hot beverages, such as coffee, in which the apparatus 100 is incorporated.

At the end that is axially opposite to the opening 20, the hollow body 15 has a second opening 21, which provides access to a cylindrical axial cavity 22. The latter terminates with the end 23, which is located inside the cylindrical cavity 17.

The axial cavity 22 has a cylindrical rod 24 positioned therein, which is susceptible of axially moving along the axis X-X. The first end 25 of the rod 24 is designed to remain outside the cavity 22, to cooperate with the control lever 14 for controlling the valve 12, as further described below, whereas the second end 26 is designed to reach into the cylindrical cavity 17.

The hydraulic seal between the rod 24 and the inner wall of the axial cavity 22 is provided by the O-rings 27, 28, 29 and 30, this latter being placed against the abutment 31 from which the final section 32 of the rod 24 extends.

An annular groove 33 is provided on such rod 24, between the location of the O-ring 28 and the location of the O-ring 29 and, as further explained below, when the rod 24 is placed within the axial cavity 22, the sections 34 and 35 of the steam delivery pipe 36 open out therein, when the valve 12 is controlled to perform the aforementioned task.

Thus, the sections 34 and 35 open into the cavity 37 of the connection 38 whereat the wand 9 of the apparatus 100 is connected.

A first section 40 of the conduit 41 for draining condensate formed in the valve 12 and in the conduit 11, upstream therefrom, radially extends at the end portion 39 on the side of the end 23 of the axial conduit 22, for draining it also remote the area in which the valve 12 operates.

Referring to FIGS. 3, 4 and 5, in combination with FIG. 2, a cylindrical element, generally referenced 42, is shown inside the cavity 17 of the cylindrical body 15, which acts as a flow regulator.

This cylindrical element 42 has a central through hole 43 and a first axial sleeve 44 that faces the end portion 39 of the axial cavity 22, in which said sleeve fits through an opening 23 of such axial cavity 22 with the interposition of an O-ring 45.

Such cylindrical element 42, as shown in the exploded perspective view of FIG. 7, in the outer cylindrical surface 46 of the collar portion 47, arranged around the axial sleeve 44, with the formation of an annular recess 48, has a plurality of flutes 49 formed on such outer surface 46.

These flutes can be formed in the form of axial grooves or may be designed as a helical groove.

An annular element 50 is concentrically radially fitted to the inner wall of the cavity 17, on the portion 47 in the form of a collar. As the cylindrical element 42 is displaced, parallel to the axis X-X, relative to the said annular element 50, the opening of the said flutes 49 is entirely or partially exposed.

An additional O-ring 51 is placed between the annular element 50 and the cylindrical element 42.

The cylindrical element 42 has an annular cavity 52 on the face opposite the one in which the first axial sleeve 44 is formed, and a second axial sleeve 53 extends from the center of the annular cavity 52, with a central hole that extends in line the axial hole 43 of the opposite sleeve 44.

Such second axial sleeve 53 has the piston head 54, with a gasket 55, frontally engaged thereagainst and biased by a pack 56 of elastic members, such as Belleville washers, which acts against the end of a sleeve 57, that extends along the axis X-X, and is part of a body 58 that forms a plug for closing the cavity 17 of the cylindrical body 15.

The aforementioned plug body 58, at its external end, is equipped with the connection 13 for the conduit 11 that carries the steam from the boiler 1.

A channel 59 is formed inside the connection 13 and the plug body 58, for carrying the steam that flows through radial channels 60, 61, and can thus reach the chamber 62 that is part of the cavity 17 of the cylindrical body 15.

The plug body 58 also forms an abutment for a helical spring, referenced 63, which engages in the annular cavity 52 of the body 42, and holds it against the annular element 50.

The piston head 54 is connected to the end of a control rod 64 which axially fits into the steam inlet conduit 59.

Referring to FIG. 6, it may be noted that the lever 14 for controlling the valve 12, which is mounted to the cylindrical body 15 thereof via a pin 16, and may thus be angularly moved around such pin, has a recess 65 whose bottom is formed with a plurality of steps 66, 67, 68 having different depths in the body of the lever.

The control rod 24 for controlling the valve 12 extends inside the recess 65 and, according to the position of the lever 14, contacts with its end 25 one of the steps 66, 67, 68 of the bottom of the recess, each of which corresponds to a respective axial position of the control rod inside the channel 22 and hence to a respective operating mode of the valve.

For example, in the arrangement that is schematically shown in FIG. 6, the position of the lever 14 that allows the end 25 of the rod 24 to reach against the deepest step 66, causes the rod 24, as shown in FIG. 3 to be positioned with the piston head 54, with the gasket 55, biased by the pack of elastic members 56 against the flow regulating body 42, to thereby closing access to the axial passage 43 with the same flow regulating body 42 being biased by the spring 63 against the annular element 50 in the cavity 17, and blocking the connection with the channel 36 and hence with the further steam delivery channels 34, 35 and 37.

In these conditions the valve 12 is in the closed or standby position.

An angular displacement of the lever 14 moves the free end 25 of the rod 24 to the shallowest step 67 and leads to a different axial position of the rod 24, as shown for example in FIG. 4, in which the end 26 of the rod 24 causes the piston head 55 to be only displaced, to overcome the bias of the pack of springs 56, and cause the axial passage 43 to be opened and the condensate formed in the cylindrical cavity 17 to be drained to the end section 39 of the axial conduit 22, and eventually to the drain conduits 40, 41.

Any further angular displacement of the lever 14 causes the end 25 of the rod 24 to engage with the step 68, and to axially displace the rod 24 to the position as shown, for example, in FIG. 5, in which the shoulder 30, with the O-ring 31, causes axial displacement of the flow regulating body 42, by frontally engaging with the first sleeve 44, and blocking the channel 43 to prevent the passage of steam to the condensate draining conduits 40, 41.

Such displacement causes partial or total exposure of the flutes 49 formed on the cylindrical surface 46, relative to the annular element 50.

These flutes allow the cylindrical chamber 17 to be only connected with the conduit 36 which allows the steam to reach the connection 38 connected to the wand 9, via the conduits 34, 35.

With all the other passages closed, the valve 12 will be only able to deliver steam at the maximum flow rate, assuming that the step 68 has such as depth as to allow the axial slits 49 to be entirely opened, by relative positioning of the rod 24.

Otherwise, by changing the number of steps of the bottom of the recess 66 and by changing their depth relative to the step 68, or namely reducing it, the different axial positioning of the control rod 24 will cause the axial slits 49 to be partially opened and a predetermined reduced delivery of the flow of steam to be established by the respective depth of the steps of the recess 66.

Therefore, with the apparatus of the invention, the condensate formed when the apparatus is idle may be drained from the valve 12, and different steam dispensing flows may be automatically established according to the type of heating to be provided, i.e. depending on the amount of liquid to be heated or frothed, if the liquid is milk, thereby affording power savings and cost effectiveness.

1. A steam dispensing apparatus for hot beverage preparation, the apparatus comprising:
a boiler configured to generate steam and comprising a first outlet;
a steam wand configured to introduce steam into a container;
a steam delivery conduit connected to the first outlet of the boiler and configured to deliver the steam to the wand;
characterized by comprising a valve for dispensing steam to the wand and draining the condensation water formed in the valve and in the steam delivery conduit upstream from the valve, during the closing time of the valve elapsed from a previous dispensing operation, said valve being interposed between the wand and the steam delivery conduit and comprising:
a predominantly longitudinal hollow body extending along a longitudinal axis, said hollow body comprising:
an axial cavity, a steam inlet connection, located at one axial end of the hollow body, said inlet connection being connected to said steam delivery conduit to receive steam from the boiler and deliver it into said cavity;
a steam outlet connection, connected to said wand for delivering steam to said wand;
a condensation water drain connection;
a rod, axially accommodated in a channel having an opening facing out of the valve formed in said hollow body and ending with an opening that opens into said cavity, which is designed to perform axial movements in both directions along said longitudinal axis;
a control lever operably engaged with said rod to accommodate said axial movements thereof under the bias of elastic members from a closed position, said rod being adapted to create passages for establishing hydraulic communication between said inlet connection and said drain connection, by a first axial movement of said rod, and to establish hydraulic communication between said inlet connection and the outlet connection communication with said wand, in response to a second axial movement of the rod.

2. An apparatus as claimed in claim 1, wherein:
said cavity of the hollow body includes a cylindrical element for adjusting the steam flow, said cylindrical element having a central through hole and a first axial sleeve that faces the end portion of said axial cavity, in which said first sleeve fits through an opening of said axial cavity with the interposition of an O-ring.

3. An apparatus as claimed in claim 2, wherein said cylindrical element has a collar portion whose outer cylindrical surface placed around said first axial sleeve, thereby forming an annular gap, is formed with a plurality of grooves arranged thereon.

4. An apparatus as claimed in claim 3, characterized in that said cylindrical element is operably connected to an annular element, concentrically disposed on the collar portion which partially or entirely exposes the opening of said grooves upon axial displacement of said cylindrical element parallel to the axis.

5. An apparatus as claimed in claim 1, characterized in that said cavity of said hollow body includes a piston head, having a seal that rests against the opening of said axial through hole of said cylindrical element, that faces the interior of said cavity, a rod, connected with one of its ends to said piston head and axially accommodated in the steam delivery conduit formed within a cap-like body, which is adapted to close said cavity of said cylindrical body, a pack of elastic elements being interposed between said piston head and said cap-like body to keep said piston head adherent against the opening of said axial through hole of said cylindrical element, facing the interior of said cavity.

6. An apparatus as claimed in claim 1, characterized in that said cavity of said cylindrical body comprises an elastic member between said cylindrical element for adjusting the steam flow and said cap-like body for biasing said cylindrical element against the opening of the terminal portion of said axial conduit that faces said cavity.

7. An apparatus as claimed in claim 1, characterized in that said control lever, operably engaged with said rod to accommodate the axial movements of the latter from a closed position, comprises a recess whose bottom is formed with a plurality of steps having different depths in the lever body, said control rod for controlling the valve having its end in contact with one of the steps of the bottom of the recess, according to the angular position assumed by the lever, each corresponding to a respective axial position of said control rod in the channel and hence to a respective operating mode of the valve.
